(19) United States
(12) Patent Application Publication
(10) Pub. No.: US 2025/0135922 A1
(43) Pub. Date: May 1, 2025

(54) MULTI-INPUT CHARGING DEVICE AND METHOD

(71) Applicants: Hyundai Motor Company, Seoul (KR); Kia Corporation, Seoul (KR)

(72) Inventors: Hosun Jang, Suwon-si (KR); Kyung Moo Lee, Yongin-si (KR); Seunghyeon Bin, Hwaseong-si (KR)

(21) Appl. No.: 18/443,528

(22) Filed: Feb. 16, 2024

(30) Foreign Application Priority Data
Oct. 30, 2023 (KR) 10-2023-0146287

(51) Int. Cl. B60L 53/16; B60L 53/62; H01R 13/703

(52) U.S. Cl. CPC B60L 53/16; B60L 53/62; H01R 13/7037; H01R 2201/26

(57) ABSTRACT

An embodiment multi-input charging device includes a disconnector actuator system (DAS) controller configured to release an engagement of a DAS in response to receipt of a multi-charging input signal, a charging efficiency calculator configured to calculate a charging efficiency of a battery according to a rotor position of a rotor of a drive motor, a rotor controller configured to change the rotor position through a motor speed control until a particular rotor position having a highest charging efficiency is detected, and a charging controller configured to start multi-charging at the particular rotor position.

### CROSS-REFERENCE TO RELATED APPLICATIONS

This application claims the benefit of Korean Patent Application No. 10-2023-0146287, filed on Oct. 30, 2023, which application is hereby incorporated herein by reference.

### TECHNICAL FIELD

The present disclosure relates to a multi-input charging device and method.

### BACKGROUND

In electric vehicles, energy from a high-voltage battery is transferred to the drive motor through DC to AC power conversion in an inverter to drive the vehicle.

There are two types of charging methods for high-voltage batteries: slow charging and fast charging. Among them, the fast charging method is a method of charging power converted to DC from an external charging infrastructure directly into the battery at high power through fast electric vehicle supply equipment (EVSE), and currently, 50 kW-500V/100A, 100 kW-500V/200A, 200 kW-500V/400A, 400 kW-1000V/400A infrastructure exists worldwide.

For example, in the case of an 800V-class battery system, a 1000V-class fast-charging infrastructure may be used by the existing fast-charging method, but when using a 500V-class infrastructure, the quick charger output voltage is only up to 500V (maximum 450V control considering margin), so power supply is limited and for this, an intermediate pressure boosting process is necessary. The vehicle under development uses the motor's coil and the inverter's power conversion switch to boost voltage. This method of fast charging in 500/1000V class infrastructure through motors and inverters is called a multi-input charging method.

### SUMMARY

The present disclosure relates to a multi-input charging device and method. Particular embodiments relate to a multi-input charging device and method capable of increasing the charging efficiency by using a disconnector actuator system (DAS) in the case of multi-input charging.

Embodiments of the present disclosure provide a multi-input charging device and method capable of performing multi-charging at a rotor position having the optimal charging efficiency by changing the rotor position of the drive motor during multi-charging by using a disconnector actuator system (DAS) and calculating a charging efficiency depending on the rotor position.

A multi-input charging device may include a DAS controller configured to release coupling of a disconnector actuator system when a multi-charging input signal is received, a charging efficiency calculator configured to calculate a charging efficiency of the battery according to a rotor position of a drive motor, a rotor controller configured to change the rotor position through a motor speed control until a particular rotor position having a highest charging efficiency is detected, and a charging controller configured to start multi-charging at the particular rotor position.

When a multi-charging protection mode is set, the DAS controller may be configured to confirm conditions of parking gear engagement and motor speed of 0 KPH (kilometer per hour) and to release engagement of the DAS in response to the multi-charging input signal received from a charging station.

When the rotor is fixed at the particular rotor position, the DAS controller may be configured to engage the DAS again.

The charging efficiency calculator may be configured to calculate a charging efficiency of the battery by comparing an input voltage and an input current input from a charging station to the battery with an output voltage and an output current of the battery.

The rotor controller may be configured to rotate the rotor by a particular angle at each preset period.

The particular angle may be an angle of a resolver corresponding to an electrical angle of a predetermined level.

When the rotor position is changed at each preset period, the charging efficiency calculator may be configured to calculate a first charging efficiency of the battery at a rotor position before the change and a second charging efficiency of the battery at a rotor position after the change.

When the second charging efficiency is higher by comparing the first charging efficiency and the second charging efficiency, the rotor controller may be configured to continue to change the rotor position.

When the first charging efficiency is equal to a second charging efficiency or higher than the second charging efficiency by comparing the first charging efficiency and the second charging efficiency, the rotor controller may be configured to fix the rotor position to the rotor position before the change.

The particular rotor position may be a rotor position at the time when a rotor and a stator of the drive motor are aligned.

A multi-input charging method may include releasing coupling of a DAS when a multi-charging input signal is received, confirming an initial rotor position of a drive motor, calculating a charging efficiency of the battery at the initial rotor position through an initial charging current, changing a rotor position through a motor speed control, calculating the charging efficiency of the battery at the changed rotor position, changing the rotor position until a particular rotor position having a highest charging efficiency is detected, fixing the rotor position to the particular rotor position when the particular rotor position is detected, and starting multi-charging by engaging the DAS again.

The releasing engagement of the DAS when the multi-charging input signal is received may include confirming conditions of parking gear engagement and motor speed of 0 KPH and releasing engagement of the DAS in response to the multi-charging input signal received from a charging station, when a multi-charging protection mode is set.

The confirming the initial rotor position of the drive motor may include confirming the initial rotor position based on an angle detected through a resolver of the stopped drive motor.

The changing the rotor position may include rotating a resolver angle of the rotor by a particular angle at each preset period.

The calculating the charging efficiency of the battery at the changed rotor position may include calculating the charging efficiency of the battery by comparing an input voltage and an input current input from a charging station to the battery with an output voltage and an output current of the battery.

The changing the rotor position until a particular rotor position having the highest charging efficiency is detected may include continuing to change the rotor position, when the second charging efficiency is higher by comparing a first charging efficiency of the rotor position before the change with a second charging efficiency of a rotor position after the change at each period.

The changing the rotor position until a particular rotor position having the highest charging efficiency is detected may further include stopping the changing of the rotor position, when the first charging efficiency is equal to the second charging efficiency or higher than the second charging efficiency by comparing a first charging efficiency of a rotor position before the change with a second charging efficiency of a rotor position after the change at each period.

The fixing the rotor position to the particular rotor position when the particular rotor position is detected may include determining the rotor position before the change having the first charging efficiency as the particular rotor position and fixing the rotor position to the particular rotor position.

The particular rotor position may be a rotor position at the time when a rotor and a stator of the drive motor are aligned.

The rotating the resolver angle of the rotor by the particular angle may include rotating an angle of the rotor by an electrical angle corresponding to the particular angle.

A multi-input charging device and method according to an embodiment may perform multi-charging at a rotor position having the optimal charging efficiency by changing the rotor position of the drive motor during multi-charging by using a disconnector actuator system (DAS) and calculating a charging efficiency depending on the rotor position.

### BRIEF DESCRIPTION OF THE DRAWINGS

FIG. 1 shows a multi-input charging method according to an embodiment.

FIG. 2 is a block diagram showing a multi-input charge system including a multi-input charging device according to an embodiment.

FIG. 3 is a block diagram showing a multi-input charging device of FIG. 2 according to an embodiment.

FIGS. 4A and 4B show a rotor of a drive motor according to an embodiment.

FIG. 5 is a graph showing charging efficiency depending on a resolver angle according to an embodiment.

FIG. 6 is a flowchart of a multi-input charging method according to an embodiment.

FIG. 7 is a flowchart of a multi-input charging method according to an embodiment.

FIG. 8 is a drawing for explaining a computing device according to an embodiment.

### DETAILED DESCRIPTION OF ILLUSTRATIVE EMBODIMENTS

Embodiments of the disclosure will be described more fully hereinafter with reference to the accompanying drawings such that a person of ordinary skill in the art may easily implement the embodiments. As those skilled in the art would realize, the described embodiments may be modified in various different ways, all without departing from the spirit or scope of the embodiments of the present disclosure. In order to clarify the embodiments of the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinal number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, embodiments of the present disclosure will be described with reference to the drawings.

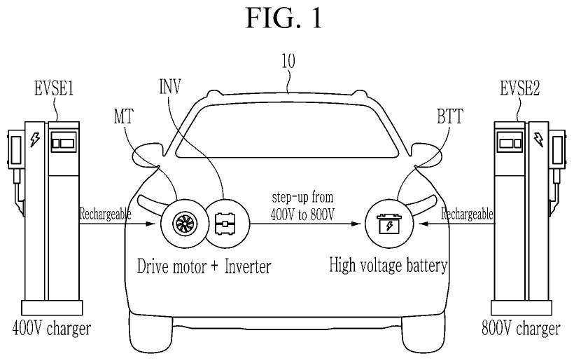

FIG. 1 shows a multi-input charging method according to an embodiment. In the multi-input method, the term multi does not mean charging multiple devices at the same time, but rather means that 400V fast charging is possible, and 800V fast charging is also possible. That is, both a first charging station EVSE1, which includes a 400V charger, and a second charging station EVSE2, which includes an 800V charger, may be used.

In FIG. 1, in the case of a vehicle 10 including an 800V high-voltage battery BTT, charging may be performed using an existing method at the second charging station EVSE2. However, in the case of the first charging station EVSE1, the charger output voltage is only 400V at maximum, so a step-up process is necessary to supply power. Therefore, in the multi-input charging method, the output voltage of the first charging station EVSE1 must be boosted and used through a driving motor MT and an inverter INV.

That is, the multi-input charging method enables fast charging of the vehicle 10 by using both the first charging station EVSE1 and the second charging station EVSE2.

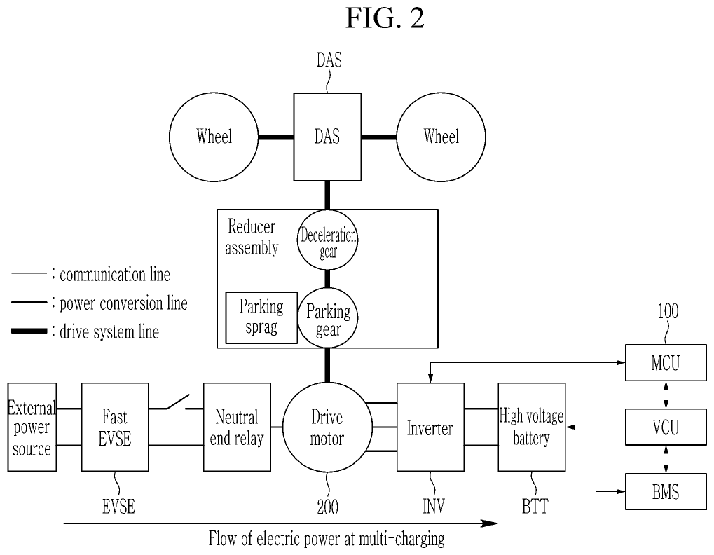

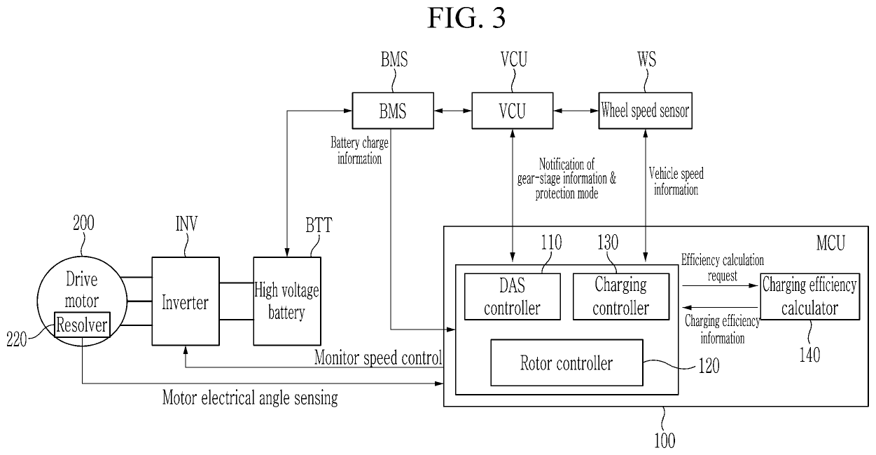

FIG. 2 is a block diagram showing a multi-input charge system including a multi-input charging device according to an embodiment. FIG. 3 is a block diagram showing a multi-input charging device of FIG. 2 according to an embodiment.

In FIG. 2 and FIG. 3, a disconnector actuator system (DAS) may be disposed between a drive motor 200 and a drive shaft (or drive line) between both wheels. The DAS may separate or connect the drive motor 200 and the drive shaft depending on the driving situation. That is, when the DAS is coupled, the drive motor 200 is connected to the drive shaft, and when an engagement of the DAS is released, the drive motor 200 is separated from the drive shaft.

The drive motor 200 may be separated from or connected to the drive shaft on which wheels are mounted through the DAS. The drive motor 200 may be electrically connected to a fast electric vehicle supply equipment (EVSE) through an inverter neutral end relay. The drive motor 200 stores and transmits electrical energy during inverter switching using the stator inductance component.

The fast EVSE corresponds to a fast charging station. The fast EVSE may communicate with a vehicle internal controller, so as to transmit and receive vehicle information with respect to the EVSE.

The neutral end relay (i.e., the inverter neutral end relay) may be electrically connected to the inverter INV. The neutral end relay may be connected to the inverter INV so as to boost DC power receive through the fast EVSE connected to an external power source.

The inverter INV may boost the DC power of the external power source through a pulse width modulation (PWM) control of internal semiconductor switch (IGBT) and transfer the electrical energy to the high-voltage battery BTT.

A parking gear may be disposed in a reducer assembly, rotate with the drive shaft, and when a parking sprag is engaged, prevent transfer of driving torque generated by the drive motor 200.

A motor control unit (MCU) may send various information (e.g., current, temperature, and position) to drive the motor and may perform various controls such as an inverter control, an inverter and motor fault diagnosis, and a cooperative control. The MCU is applied to components within the vehicle to perform control, judgement, diagnosis, and the like, thereby performing functions of driving or charging the electric vehicle.

The MCU may include a multi-input charging device 100. The MCU may be electrically connected to various sensors including a wheel speed sensor WS, a vehicle control unit (VCU), and a battery management system (BMS). That is, the multi-input charging device 100 may be electrically connected to the various sensors, the VCU, and the BMS. The MCU may receive various information from various sensors, the VCU, and the BMS. The MCU may perform various controls with respect to in-vehicle component parts including various sensors, the VCU, and the BMS.

The VCU is a higher-level controller of the vehicle and may manage cooperative control with other controllers.

The BMS may perform state monitoring, fault diagnosis, and cooperative control of the high-voltage battery BTT.

In FIG. 3, the multi-input charging device 100 may be included in the MCU and may be implemented through the MCU. Referring to FIG. 3, the multi-input charging device 100 may include a DAS controller 110, a rotor controller 120, a charging controller 130, and a charging efficiency calculator 140. The multi-input charging device 100 may be electrically connected to the drive motor 200, the inverter INV, the VCU, the BMS, the wheel speed sensor WS, and the like.

When a multi-charging input signal is received, the DAS controller 110 may release the engagement of the DAS.

When a multi-charging protection mode is set, the DAS controller 110 may confirm the parking gear engage and motor speed 0 KPH (kilometer per hour) condition and may release the engagement of the DAS in response to the multi-charging input signal received from the charging station.

When the rotor is fixed at a particular rotor position having a highest charging efficiency, the DAS controller 110 may engage the DAS again.

The rotor controller 120 may change a rotor position (i.e., a position of the rotor) through a motor speed control until the particular rotor position having the highest charging efficiency is detected.

The rotor controller 120 may rotate an angle of a resolver 220 of the rotor by a particular angle at each preset period. The particular angle may be an angle of the resolver 220 corresponding to an electrical angle of a predetermined level. For example, the rotor controller 120 may rotate the rotor by electrical angle 3 degrees at each period. The rotor controller 120 may detect the changed rotor position by sensing the angle of the resolver 220 after rotation.

When the second charging efficiency is higher by comparing a first charging efficiency according to a rotor position before the change with a second charging efficiency according to a rotor position after the change, the rotor controller 120 may continue to change the rotor position. When the first charging efficiency is equal to the second charging efficiency or the first charging efficiency is higher than the second charging efficiency by comparing the first charging efficiency with the second charging efficiency, the rotor controller 120 may fix the rotor position to the rotor position before the change. When the first charging efficiency of the rotor position before the change is higher than the first charging efficiency of the rotor position after the change, the rotor controller 120 may consider the first charging efficiency at the rotor position before the change as the highest charging efficiency.

The particular rotor position having the highest charging efficiency may be a rotor position at the time when a rotor and a stator of the drive motor are aligned.

When the rotor position is fixed at the particular rotor position having the highest charging efficiency, the charging controller 130 may start multi-charging.

The charging efficiency calculator 140 may calculate a charging efficiency of the battery according to the rotor position of the drive motor.

The charging efficiency calculator 140 may compare an input voltage and an input current input from the charging station (i.e., the EVSE) to the battery with the output voltage and an output current of the battery, and thereby calculate the charging efficiency of the battery. That is, the charging efficiency calculator 140 may calculate a battery output power/battery input power, and thereby calculate the charging efficiency.

When the rotor position is changed at each preset period, the charging efficiency calculator 140 may calculate the first charging efficiency of the battery at the rotor position before the change and the second charging efficiency of the battery at the rotor position after the change.

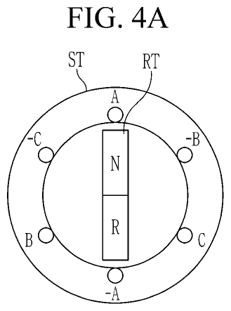

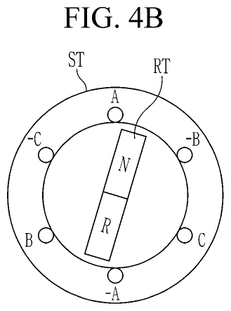

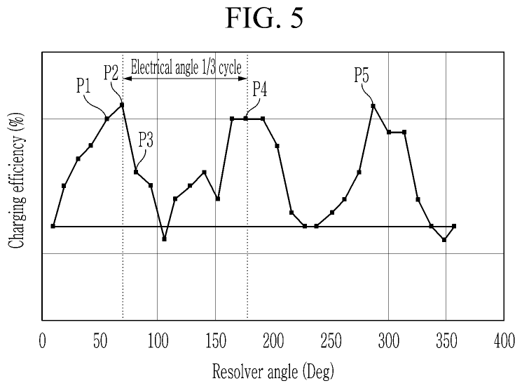

FIGS. 4A and 4B show a rotor and a stator of the drive motor according to an embodiment. FIG. 5 is a graph showing the charging efficiency depending on a resolver angle according to an embodiment.

In an embodiment, even when the parking gear is engaged, the rotor position of the drive motor may be changed according to the release of the engagement of the DAS. That is, when the DAS is released, since the drive motor and the drive shaft are not connected even if the parking gear is engaged, the rotor may be rotated.

When the vehicle is stopped, the rotor is stopped at an arbitrary position. For example, when the vehicle is stopped, the rotor may be in one of positions of FIG. 4A and FIG. 4B.

FIG. 4A shows that a rotor RT and a stator ST are aligned. FIG. 4B shows that the rotor RT and the stator ST are misaligned. One of FIG. 4A and FIG. 4B may be the rotor position before the change, and the other one may be the rotor position after the change.

For example, FIG. 4A may be the rotor position before the change, and FIG. 4B may be the rotor position after the change. In the rotor position before the change of FIG. 4A, the stator and the rotor are aligned, and in the rotor position after the change of FIG. 4B, the stator and the rotor are misaligned. Therefore, according to an embodiment, before starting multi-charging, the rotor may be fixed to the rotor position before the change.

In FIG. 5, the resolver angle may change in a mechanical angle range of 0 degrees to 360 degrees. In the 0 degrees to 360 degrees mechanical angle range, the electrical angle may have 1 cycle. The rotor may be aligned with the stator at each electrical angle of ⅓ cycle. That is, at each electrical angle of ⅓ cycle, the rotor may be fixed to the rotor position before the change having the highest charging efficiency. In FIG. 4, at each electrical angle of ⅓ cycle, the rotor RT may be aligned with the stator ST, in one of a section A (A and −A), a section B (B and −B), and a section C (C and −C).

For example, a resolver angle at a second point P2 is about 60 degrees, and a resolver angle at a fourth point P4 is about 180 degrees. Then, the electrical angle of ⅓ cycle may correspond to a mechanical angle of 120 degrees interval. Therefore, at the second point P2, the rotor RT may be aligned with the stator ST in the section A, and at the fourth point P4, the rotor RT may be aligned with the stator ST in the section C.

For example, when the rotor position is changed to have a resolver angle of the second point P2 from at the rotor position before the change having a resolver angle of a first point P1, the charging efficiency at the rotor position after the change is higher than the charging efficiency at the rotor position before the change. Therefore, the rotor position may continue to be changed from the second point P2 to a third point P3.

The charging efficiency at the rotor position after the change having a resolver angle of the third point P3 is lower than the charging efficiency at the rotor position before the change having the resolver angle of the second point P2. Therefore, the rotor position may be fixed to the rotor position before the change, so as to have the resolver angle of the second point P2.

When a resolver angle of the fourth point P4 is the rotor position before the change, the charging efficiency at a resolver angle of a subsequent point is the same as the charging efficiency of the fourth point P4. Therefore, the rotor may be fixed to the fourth point P4.

When a resolver angle of an immediately previous point of the fourth point P4 is the rotor position before the change, the charging efficiency at the resolver angle of the fourth point P4 is equal to the charging efficiency at the resolver angle of the immediately previous point. Therefore, the rotor may be fixed to the immediately previous point of the fourth point P4.

At a resolver angle of a fifth point P5, the charging efficiency is highest. At the resolver angle of the fifth point P5, the rotor RT and the stator ST may be aligned. For example, the resolver angle of the fifth point P5 may be the rotor position at which the rotor is aligned with the stator in the section B according to the electrical angle of ⅓ cycle.

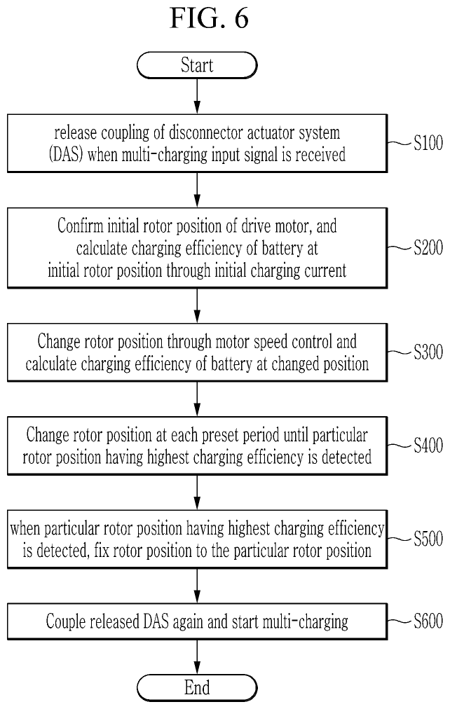

FIG. 6 is a flowchart of a multi-input charging method according to an embodiment. The multi-input charging method of FIG. 6 may be performed through the multi-input charging device of FIG. 3.

In FIG. 6, at step S100, when the multi-charging input signal is received, the multi-input charging device 100 (refer to FIG. 3) may release the engagement of the DAS.

When the multi-charging protection mode is set, the multi-input charging device 100 may confirm conditions of parking gear engagement and motor speed of 0 KPH and may release engagement of the DAS in response to the multi-charging input signal received from the charging station.

At step S200, the multi-input charging device 100 may confirm an initial rotor position of the drive motor and calculate the charging efficiency of the battery at the initial rotor position through an initial charging current. The multi-input charging device 100 may confirm the initial rotor position based on an angle detected through the resolver of the stopped drive motor.

At step S300, the multi-input charging device 100 may change the rotor position through the motor speed control and may calculate the charging efficiency of the battery at the changed rotor position.

The multi-input charging device 100 may rotate the resolver angle of the rotor by the particular angle at each preset period. Here, the particular angle may be calculated as an electrical angle. That is, the particular angle may be calculated as an electrical angle corresponding to a particular resolver angle.

The multi-input charging device 100 may compare the input voltage and the input current input from the charging station to the battery with the output voltage and the output current of the battery, and thereby calculate the charging efficiency of the battery.

At step S400, the multi-input charging device 100 may change the rotor position until the particular rotor position having the highest charging efficiency is detected.

When the second charging efficiency is higher by comparing the first charging efficiency of the rotor position before the change with the second charging efficiency of the rotor position after the change at each period, the multi-input charging device 100 may continue to change the rotor position.

When the first charging efficiency is equal to the second charging efficiency or the first charging efficiency is higher than the second charging efficiency by comparing the first charging efficiency of the rotor position before the change with the second charging efficiency of the rotor position after the change at each period, the multi-input charging device 100 may stop changing of the rotor position.

At step S500, when the particular rotor position is detected, the multi-input charging device 100 may fix the rotor position to the particular rotor position.

The multi-input charging device 100 may determine the rotor position before the change having the first charging efficiency equal to or higher than the second charging efficiency as the particular rotor position having the highest charging efficiency and fix the rotor position to the particular rotor position. Here, the particular rotor position may be the rotor position at which the rotor and the stator of the drive motor are in an aligned state or in an effectively aligned state.

At step S600, the multi-input charging device 100 may engage the DAS again and start multi-charging.

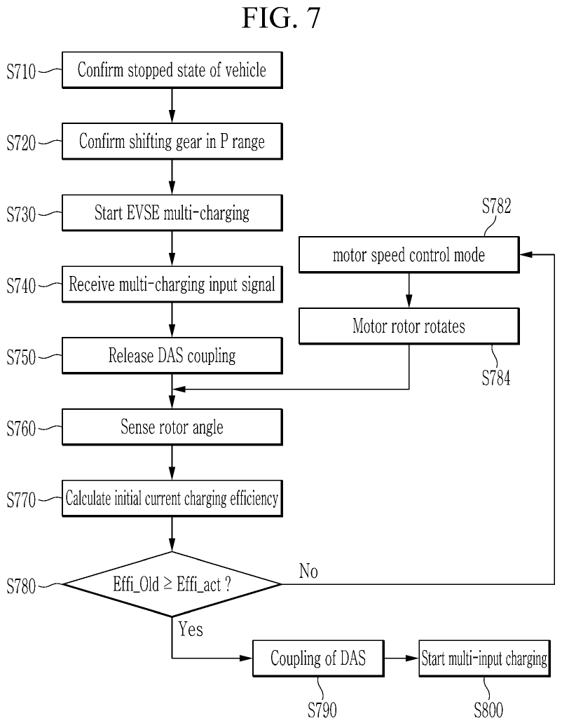

FIG. 7 is a flowchart of a multi-input charging method according to an embodiment. The multi-input charging method of FIG. 7 may be performed through the multi-input charging device. The description will be made with reference to FIG. 3.

At step S710, in FIG. 7, the multi-input charging device 100 may confirm the stopped state of the vehicle through the wheel speed sensor WS.

At step S720, the multi-input charging device 100 may confirm the P range of the shifting gear through the VCU. That is, the multi-input charging device 100 may confirm whether the parking gear is engaged, through the VCU.

At step S730, the multi-input charging device 100 may establish connection to the EVSE in order to start the EVSE multi-charging.

At step S740, the multi-input charging device 100 may receive the multi-charging input signal. The multi-input charging device 100 may receive the multi-charging input signal through the VCU.

At step S750, the multi-input charging device 100 may release the DAS engage.

At step S760, the multi-input charging device 100 may confirm the rotor position at current status. The multi-input charging device 100 may confirm the rotor position by sensing the resolver angle.

At step S770, the multi-input charging device 100 may calculate the charging efficiency at the current rotor position through the initial charging current.

At step S780, the multi-input charging device 100 may compare the first charging efficiency Effi_Old before changing of the rotor position with the second charging efficiency Effi_act after changing the rotor position, and thereby may confirm whether the first charging efficiency Effi_Old is greater than or equal to the second charging efficiency Effi_act.

That is, the multi-input charging device 100 may compare the first charging efficiency Effi_Old at the initial rotor position with the second charging efficiency Effi_act after changing the rotor position, and thereby may confirm whether the first charging efficiency Effi_Old is greater than or equal to the second charging efficiency Effi_act. At step S790, when the first charging efficiency Effi_Old is greater than or equal to the second charging efficiency Effi_act at the initial rotor position, the multi-input charging device 100 may engage the DAS again.

Thereafter, at step S800, the multi-input charging device 100 may start multi-charging.

At step S782, when the first charging efficiency Effi_Old is smaller than the second charging efficiency Effi_act after changing the rotor position at the initial rotor position, the multi-input charging device 100 may change the rotor position of the drive motor through the motor speed control mode.

At step S784, the multi-input charging device 100 may rotate the rotor through the motor speed control. The multi-input charging device 100 may move the resolver angle of the rotor by the particular angle at each preset period.

For example, the multi-input charging device 100 may rotate the rotor by an electrical angle of 3 degrees at each period. The rotor position before the change may be a rotor position before the electrical angle is rotated by 3 degrees, and the rotor position after the change may be the rotor position after the electrical angle is rotated by 3 degrees. The preset period may be 10 ms to 100 ms.

At step S760, thereafter, the multi-input charging device 100 may sense the rotor position after the change through the resolver angle.

At step S770, in addition, the multi-input charging device 100 may apply a preset current at the rotor position after the change and thereby detect the charging efficiency.

That is, the multi-input charging device 100 may rotate the rotor by a particular electrical angle at each period, apply a preset current (e.g., 10A), and thereby detect the charging efficiency.

At step S782 and S784, when the second charging efficiency is higher by comparing the first charging efficiency Effi_Old of the rotor position before the change with the second charging efficiency Effi_act of the rotor position after the change, the multi-input charging device 100 may continue to change the rotor position through the motor speed control mode.

When the first charging efficiency Effi_Old of the rotor position before the change is equal to the second charging efficiency Effi_act of the rotor position after the change or the first charging efficiency Effi_Old is higher than the second charging efficiency Effi_act, the multi-input charging device 100 may stop changing of the rotor position and fix the rotor to the rotor position before the change.

At step S790, when the rotor is fixed, the multi-input charging device 100 may engage the DAS again.

At step S800, the multi-input charging device 100 may start multi-charging (or, multi-input charge) in a state that the DAS is engaged.

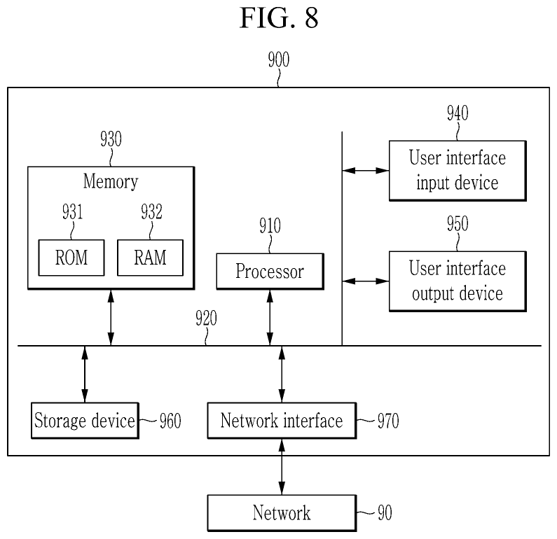

FIG. 8 is a drawing for explaining a computing device according to an embodiment.

Referring to FIG. 8, the multi-input charging device and method according to an embodiment may be implemented by using a computing device 900.

The computing device 900 may include at least one of a processor 910, a memory 930, a user interface input device 940, a user interface output device 950, and a storage device (i.e., a memory) 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 7.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside the processor 910, and the memory 930 may be connected to the processor 910 through various known means.

In some embodiments, at least some configurations or functions of the multi-input charging device and method according to an embodiment may be implemented as a program or software executable by the computing device 900, and the program or software may be stored in a computer-readable medium.

In some embodiments, at least some configurations or functions of the multi-input charging device and method according to an embodiment may be implemented by using hardware or circuitry of the computing device 900, or may also be implemented as separate hardware or circuitry that may be electrically connected to the computing device 900.

While embodiments of this disclosure have been described in connection with what is presently considered to be practical embodiments, it is to be understood that the embodiments of the disclosure are not limited to the disclosed embodiments, but, on the contrary, are intended to cover various modifications and equivalent arrangements included within the spirit and scope of the appended claims.

What is claimed is:

1. A multi-input charging device, the device comprising:
a disconnector actuator system (DAS) controller configured to release an engagement of a DAS in response to receipt of a multi-charging input signal;
a charging efficiency calculator configured to calculate a charging efficiency of a battery according to a rotor position of a rotor of a drive motor;
a rotor controller configured to change the rotor position through a motor speed control until a particular rotor position having a highest charging efficiency is detected; and
a charging controller configured to start multi-charging at the particular rotor position.

2. The device of claim 1, wherein, in a state in which a multi-charging protection mode is set, the DAS controller is configured to confirm conditions of parking gear engagement and a motor speed of 0 kilometer per hour (KPH) and to release the engagement of the DAS in response to the receipt of the multi-charging input signal from a charging station.

3. The device of claim 1, wherein, in a state in which the rotor is fixed at the particular rotor position, the DAS controller is configured to re-engage the DAS.

4. The device of claim 1, wherein the charging efficiency calculator is configured to calculate the charging efficiency of the battery by comparing an input voltage and an input current input from a charging station to the battery with an output voltage and an output current of the battery.

5. The device of claim 1, wherein the rotor controller is configured to change the rotor position by a particular angle at a preset period.

6. The device of claim 5, wherein the particular angle is an angle of a resolver corresponding to an electrical angle of a predetermined level.

7. The device of claim 5, wherein, after the rotor position is changed at the preset period, the charging efficiency calculator is configured to calculate a first charging efficiency of the battery at a first rotor position before the change and a second charging efficiency of the battery at a second rotor position after the change.

8. The device of claim 7, wherein, in response to a determination that the second charging efficiency is higher than the first charging efficiency, the rotor controller is configured to continue to change the rotor position by the particular angle at the preset period.

9. The device of claim 7, wherein, in response to a determination that the first charging efficiency is higher than or equal to the second charging efficiency, the rotor controller is configured to fix the rotor position to the first rotor position before the change.

10. The device of claim 1, wherein the rotor and a stator of the drive motor are aligned at the particular rotor position.

11. A multi-input charging method, the method comprising:
releasing an engagement of a disconnector actuator system (DAS) in response to receiving a multi-charging input signal;
confirming a first rotor position of a rotor of a drive motor;
calculating a first charging efficiency of a battery at the first rotor position through an initial charging current;
changing the first rotor position to a second rotor position through a motor speed control;
calculating a second charging efficiency of the battery at the second rotor position;
fixing the rotor to a particular rotor position, wherein the particular rotor position is a rotor position having a highest charging efficiency; and
starting multi-charging by re-engaging the DAS after fixing the rotor to the particular rotor position.

12. The method of claim 11, wherein releasing the engagement of the DAS comprises:
confirming conditions of parking gear engagement and a motor speed of 0 kilometer per hour (KPH); and
in a state in which a multi-charging protection mode is set, releasing the engagement of the DAS in response to the multi-charging input signal being received from a charging station.

13. The method of claim 11, wherein confirming the first rotor position comprises confirming the first rotor position based on an angle detected through a resolver of the drive motor in a stopped state.

14. The method of claim 11, wherein changing the first rotor position and changing the second rotor position each comprise rotating a resolver angle of the rotor by a particular angle at a preset period.

15. The method of claim 14, wherein rotating the resolver angle of the rotor by the particular angle comprises rotating an angle of the rotor by an electrical angle corresponding to the particular angle.

16. The method of claim 11, wherein calculating the first charging efficiency of the battery at the first rotor position and calculating the second charging efficiency of the battery at the second rotor position each comprise comparing an input voltage and an input current input from a charging station to the battery with an output voltage and an output current of the battery.

17. The method of claim 11, further comprising:
comparing the first charging efficiency to the second charging efficiency;
changing the second rotor position to a third rotor position in response to a determination that the second charging efficiency is higher than the first charging efficiency;
calculating a third charging efficiency of the battery at the third rotor position; and
comparing the second charging efficiency to the third charging efficiency.

18. The method of claim 17, further comprising:
determining the second rotor position is the particular rotor position in response to a determination that the second charging efficiency is higher than or equal to the third charging efficiency; and
determining the third rotor position is the particular rotor position in response to a determination that the second charging efficiency is lower than the third charging efficiency.

19. The method of claim 11, further comprising:
comparing the first charging efficiency to the second charging efficiency; and
determining the first rotor position having the first charging efficiency is the particular rotor position in response to the first charging efficiency being higher than or equal to the second charging efficiency.

20. The method of claim 11, wherein the rotor and a stator of the drive motor are aligned at the particular rotor position.
